(19) United States
(12) Patent Application Publication
(10) Pub. No.: US 2014/0036472 A1
(43) Pub. Date: Feb. 6, 2014

(54) INDICATING INSTRUMENT DIAL PLATE

(71) Applicant: YAZAKI CORPORATION, Tokyo (JP)

(72) Inventors: Hideo Ishihara, Shizuoka (JP); Hirobumi Mikami, Shizuoka (JP)

(73) Assignee: YAZAKI CORPORATION, Tokyo (JP)

(21) Appl. No.: 13/955,305

(22) Filed: Jul. 31, 2013

(30) Foreign Application Priority Data
Aug. 2, 2012 (JP) 2012-172322

(51) Int. Cl. F21V 33/00

(52) U.S. Cl. CPC F21V 33/00
USPC 362/23.14

(57) ABSTRACT

An indicating instrument dial plate includes a substrate that is formed in a plate shape, made of a transparent or semi-transparent material, has a front face including a hairline-treated surface and has a rear face which is irradiated with a dial plate illumination light from a light source inside an indicating instrument, and a half-mirror layer that is formed in a shape of a thin film covering the hairline-treated surface by sputtering and adapted to allow a portion of external light incident to the front face of the substrate from the outside of the indicating instrument to be transmitted into the substrate and to allow a portion of the external light to be reflected. The hairline-treated surface is made by forming fine line-shaped grooves on the front face of the substrate. The hairline-treated surface includes hairline-patterned unevenness which diffuses the external light.

### CROSS REFERENCE TO RELATED APPLICATION

This application is based on Japanese Patent Applications No. 2012-172322 filed on Aug. 2, 2012, the contents of which are incorporated herein by reference.

### BACKGROUND OF THE INVENTION

1. Technical Field

The present invention relates to an indicating instrument dial plate, which has a surface provided with characters, scales and the like required to notify a measured value and is adapted to be mounted on an indicating instrument.

2. Background Art

FIGS. 5 and 6 show a structure of a speedometer 101 as an indicating instrument for measuring and indicating a driving speed of vehicles.

The speedometer 101 includes a case 111; an indicating instrument dial plate 121 attached on a front face of the case 111; an indicator 132 fixedly equipped on a distal end of an indicator shaft 131 rotationally inserted through the indicating instrument dial plate 121; a control board 142 equipped with an internal machine (e.g., a motor) 141 for rotationally operating the indicator 132 (i.e., the indicator shaft 131), a control circuit for controlling an operation of the internal machine 141, or the like; a facing 151 attached in a brim shape on a front end of the case 111 to extend to an upper front side of the indicating instrument dial plate 121; and a transparent cover 161 attached on a front edge of the facing 151 to cover a front side of the indicating instrument dial plate 121.

The case 111 is a housing intended to accommodate the control board 142 or the indicating instrument dial plate 121 as described above. The case 111 has a case inside bottom wall 112 for partitioning between the control board 142 and the indicating instrument dial plate 121. Also, the case 111 is adapted to be opened and closed at a bottom thereof by a detachable bottom cover 113.

A space 115 between the case inside bottom wall 112 and the bottom cover 113 is a space for accommodating the control board 142.

The case inside bottom wall 112 has a shape of a bowl concaved toward the indicating instrument dial plate 121 and is provided at a central portion thereof with an opening 116. The opening 116 is formed to allow a driving shaft of the internal machine 141 to be inserted therethrough, thereby allowing the driving shaft of the internal machine 141 and the indicator shaft 131 to be coupled with each other.

In addition, the opening 116 of the case inside bottom wall 112 is formed to allow first light sources 143 and 144 mounted on the control board 142 to be inserted therethrough. The first light sources 143 and 144 are light sources for illuminating the indicating instrument dial plate 121.

A surface 112a of the case inside bottom wall 112 facing a rear surface of the indicating instrument dial plate 121 serves as a reflector for distributing illumination lights of the first light sources 143 and 144 over the whole area of the rear surface of the indicating instrument dial plate 121.

As shown in FIG. 5, the indicating instrument dial plate 121 has a surface, on which indexes 122, such as characters 122a and scales 122b, required to notify a measured value are arranged. The characters 122a or scales 122b are arranged on the surface of the indicating instrument dial plate 121 in a circumference shape about the rotation center of the indicator 132.

Further, a portion of the rear surface 121b of the indicating instrument dial plate 121 is colored with a background color.

Also, as shown in FIGS. 5 and 6, the indicating instrument dial plate 121 is provided with a transparent window portion 124 in which an LCD (Liquid Crystal Display) unit 180 for displaying a measured information is disposed. The LCD unit 180 is mounted on the control board 142 as shown in FIG. 6. The control board 142 is also equipped with a second light source 181 for irradiating an illumination light to the LCD unit 180.

In the speedometer 101 mounted on vehicles, design elements, such as creating a luxury feel suitable to a design of a driver's seat, as well as functionality are important.

For the recent speedometer 101, a method for creating a metallic texture on the indicating instrument dial plate 121 has been proposed to impart a luxury and courteous feel to the speedometer 101.

FIG. 7 shows an example of an indicating instrument dial plate exhibiting a metallic texture in a related art.

A indicating instrument dial plate 121a shown in FIG. 7 is hat disclosed in JP-A-2008-89479 as described below, and is used as the indicating instrument dial plate 121 shown in FIG. 6.

As shown in FIG. 7, the indicating instrument dial plate 121A includes a substrate 210, a half-mirror layer 220, a light-shielding layer 230, a colored layer 240, a smoke layer 250, and a hairline-treated surface 260.

The substrate 210 is formed in a plate shape by a transparent or semi-transparent material. The indexes 122, such as characters 122a and scales 122b, shown in FIG. 5 are arranged on a surface of the substrate 210. The substrate 210 has a rear surface on which a dial plate illumination light c1 from first light sources 143 and 144 mounted on a control board 142 is irradiated.

The half-mirror layer 220 is provided in a stated state on the rear surface of the substrate 210. The half-mirror layer 220 is adapted such that an external light c2 incident on the surface of the substrate 210 from the outside of the indicating instrument can be reflected on the rear surface of the substrate 210. Also, the half-mirror layer 220 allows the dial plate illumination light cl irradiated from the first light sources 143 and 144 to be transmitted therethrough. The dial plate illumination light c1, which is transmitted through the half-mirror layer 220 and then is incident on the substrate 210, is intactly emitted toward the rear surface of the substrate 210, so that an area inside the substrate 210, through which the dial plate illumination light cl is transmitted, emits light.

The light-shielding layer 230 is provided in a stacked state in a first region S1, which is defined by a portion of the rear surface of the substrate 210 facing the first light sources 143 and 144, so that the first region S1 is finished as a light-shielding area through which the dial plate illumination light c1 of the first light source 143 and 144 is not transmitted.

The colored layer 240 is provided in a stacked state in a third region S23 defined in a portion of a second region S2, which is an area of the rear surface of the substrate 210 except the first region Si. The colored layer 240 is a layer formed by a resin material, through which the illumination light can be transmitted. The colored layer 240 allows the dial plate illumination light c1, which is transmitted through the third region S23, to be colored by a predetermined color and then transmitted through the substrate 210. Therefore, an area of the substrate 210, which is defined as the third region S23, develops the color of the colored layer 240, thereby achieving an improvement of visibility due to coloring and the like.

The smoke layer 250 is a semi-transparent resin layer and is provided to reduce reflection of the external light c2 on the surface of the substrate 210. The smoke layer 250 reduces reflection of the external light c2 on the hairline-treated surface 260 as described below, and thus performs a function of preventing glaring of the surface of the dial plate due to excessive reflection.

In JP-A-2008-89479, the hairline-treated surface 260 is an uneven surface of a hairline pattern formed on a surface of the smoke layer 250. The hairline-treated surface 26 is that in which protrudes 261 are formed in a hairline pattern on the surface of the smoke layer 250 by a printing process. The hairline-treated surface 260 exhibits the metallic texture on the surface of the substrate 210 by diffusing the external light c2 incident on the surface of the substrate 210 by means of the hairline-patterned unevenness.

However, in the case of the indicating instrument dial plate 121A of JP-A-2008-89479, if the smoke layer 250 is not provided and thus the protrudes 261 are directly formed on the surface of the substrate 210, the diffusion and reflection of the external light c2 on the surface of the substrate 210 are excessively strong, thereby causing glaring. Provision of the smoke layer 250 as in JP-A-2008-89479 is indispensable to prevent glaring, and thus a step of providing the smoke layer 250 has to be added, thereby increasing the manufacturing steps of the indicating instrument dial plate 121A and thus occurring a matter in which the cost is increased.

In addition, in the case of the indicating instrument dial plate 121A of JP-A-2008-89479, the hairline-treated surface 260 creating the metallic texture is exposed on the surface of the indicating instrument dial plate 121A. Thus, there is a risk in which, during storage or the like, the protrusions 261 are contacted with the surrounding objects so that some of the protrusions 261 are damaged. In addition, there is a risk in which, as some of the protrusions 261 are damaged, the quality of the metallic texture is deteriorated in a portion of the surface of the indicating instrument dial plate 121A.

### SUMMARY OF THE INVENTION

An object of the present invention is to solve the above matters, and to provide an indicating instrument dial plate, in which a metallic texture design, which does not cause glaring and is stable, is embodied on a surface of the dial plate at a low cost, and the quality of the metallic texture is easily maintained.

The object of the present invention is achieved by the following configurations.
(1) According to an aspect of the invention, an indicating instrument dial plate includes a substrate that is formed in a plate shape, made of a transparent or semi-transparent material, has a front face including a hairline-treated surface and has a rear face which is irradiated with a dial plate illumination light from a light source inside an indicating instrument, and a half-mirror layer that is formed in a shape of a thin film covering the hairline-treated surface by sputtering and adapted to allow a portion of external light incident to the front face of the substrate from the outside of the indicating instrument to be transmitted into the substrate and to allow a portion of the external light to be reflected. The hairline-treated surface is made by forming fine line-shaped grooves on the front face of the substrate. The hairline-treated surface includes hairline-patterned unevenness which diffuses the external light to impart a metallic texture to the front face of the substrate.
(2) The indicating instrument dial plate of (1) further includes a light-shielding layer that is provided in a first region which is a portion of the rear face of the substrate facing the light source and shields the dial plate illumination light of the light source, and a color layer that is provided in a third region which is a portion of a second region which is the rear face of the substrate except the first region to allow the dial plate illumination light to be transmitted through the color layer and colors the dial plate illumination light transmitted through the third region predetermined color.

According to the configuration of the above (1), the hairline-patterned unevenness structure creating a metallic texture design on the surface of the dial plate is formed by providing fine line-shaped grooves on the surface of the substrate. Namely, the surface of the substrate itself is formed as the hairline-treated surface. In addition, the half-mirror layer is formed on the top of the hairline-treated surface by sputtering, and reduces the external light to be incident on the hairline-treated surface. As a result, even if a smoke layer for especially reducing the external light is not provide, the diffusion and reflection of the external light on the surface of the substrate can be inhibited, thereby preventing an occurrence of glaring.

In other words, even if the smoke layer is not provided, the metallic texture design, which does not cause glaring and is stable, is embodied on the surface of the dial plate. Therefore, by omitting the smoke layer which has been provided, the manufacturing steps of the indicating instrument dial plate can be simplified, thereby reducing the manufacturing cost of the indicating instrument dial plate. As a result, the metallic texture design, which does not cause glaring and is stable, is embodied on the surface of the dial plate at a low cost.

In addition, the hairline-patterned unevenness structure creating the metallic texture design is protected by the half-mirror layer covered thereon. Thus, it is possible to prevent the hairline-patterned unevenness structure from being damaged due to contact with the surrounding objects during storage or the like. In other words, an occurrence of a matter, in which the quality of the metallic texture is deteriorated in a portion of the surface of the dial plate due to damage of the hairline-patterned unevenness structure, is prevented.

Therefore, the quality of the metallic texture can be easily maintained, and thus, the quality control of the indicating instrument dial plate can be facilitated.

According to the configuration of the above (2), in a non-operating state of the indicating instrument, in which the dial plate illumination light is not irradiated on the rear surface of the indicating instrument dial plate, the metallic texture design, which does not cause glaring and is stable, can be imparted to the indicating instrument. Also, in an operating state of the indicating instrument, in which the dial plate illumination light is irradiated on the rear surface of the indicating instrument dial plate, the third region defined on the indicating instrument dial plate can develop the color of the colored layer. Therefore, a variety of indicating instrument dial plates, which are different in the color developing region or the developed color in the indicating instrument, can be relatively easily provided by design modifications in the shape of the third region or the color of the colored layer, and thus specification changes of indicating instruments or the like can be easily coped with.

According to the indicating instrument dial plate of the present invention, the hairline-patterned unevenness structure creating a metallic texture design on the surface of the dial plate is formed by forming fine line-shaped grooves on the surface of the substrate. Namely, the surface of the substrate itself is formed as the hairline-treated surface. In addition, the half-mirror layer is formed on the top of the hairline-treated surface by sputtering, and reduces the external light to be incident on the hairline-treated surface. As a result, even if a smoke layer for especially reducing the external light is not provide, the diffusion and reflection of the external light on the surface of the substrate is inhibited, thereby preventing an occurrence of glaring.

In other words, even if the smoke layer is not provided, the metallic texture design, which does not cause glaring and is stable, is embodied on the surface of the dial plate. Therefore, by omitting the smoke layer which has been provided, the manufacturing steps of the indicating instrument dial plate are simplified, thereby reducing the manufacturing cost of the indicating instrument dial plate. As a result, the metallic texture design, which does not cause glaring and is stable, is embodied on the surface of the dial plate at a low cost.

Further, the hairline-patterned unevenness structure creating the metallic texture design is protected by the half-mirror layer covered thereon. Thus, it is possible to prevent the hairline-patterned unevenness structure from being damaged due to contact with the surrounding objects during storage or the like. In other words, an occurrence of a matter, in which the quality of the metallic texture is deteriorated in a portion of the surface of the dial plate due to damage of the hairline-patterned unevenness structure, is prevented.

Therefore, the quality of the metallic texture is easily maintained, and thus, the quality control of the indicating instrument dial plate is be facilitated.

In the foregoing, the present invention has been briefly described. Also, details of the present invention will be further apparent, when modes (hereinafter, referred to as “embodiments”) for embodying the invention as described below are thoroughly read with reference to the accompanying drawings.

### BRIEF DESCRIPTION OF DRAWINGS

FIG. 1 is a front view showing a speedometer as one embodiment of an indicating instrument in which an indicating instrument dial plate according to the present invention is used.

FIG. 2 is a sectional view showing a structure of the indicating instrument dial plate used in the speedometer of FIG. 1.

FIG. 3 is an explanatory view showing an appearance of the indicating instrument dial plate in a non-operating state of the speedometer shown in FIG. 1 as viewed from the front thereof.

FIG. 4 is an explanatory view showing an appearance of the indicating instrument dial plate in an operating state of the speedometer shown in FIG. 1 as viewed from the front thereof.

FIG. 5 is a front view showing a speedometer for vehicles as an indicating instrument in a related art.

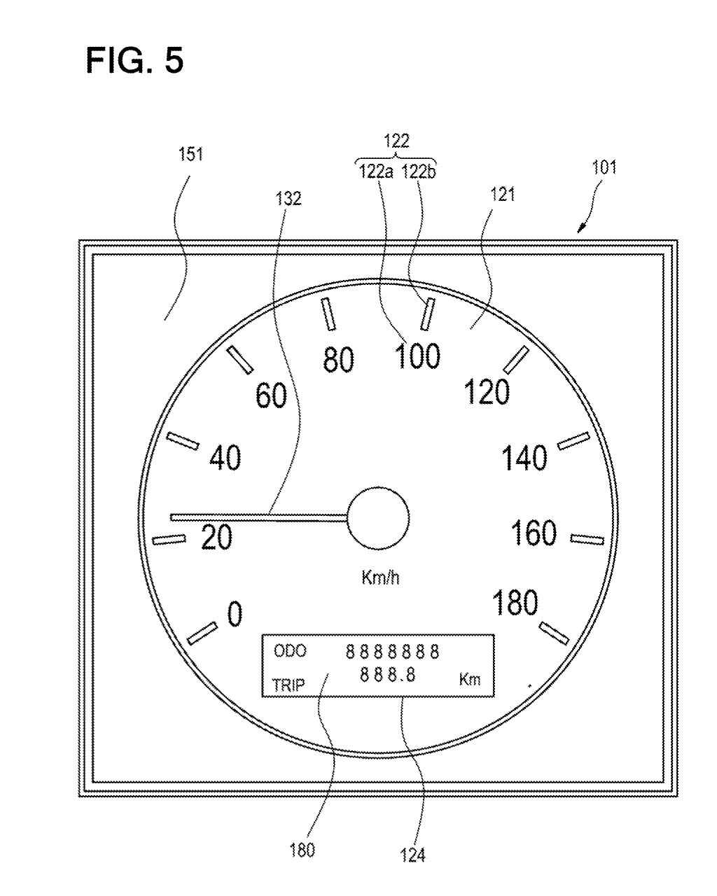

FIG. 6 is a longitudinal sectional view of the speedometer shown in FIG. 5.

FIG. 7 is a longitudinal sectional view showing a structure of an indicating instrument dial plate exhibiting a metallic texture in a related art.

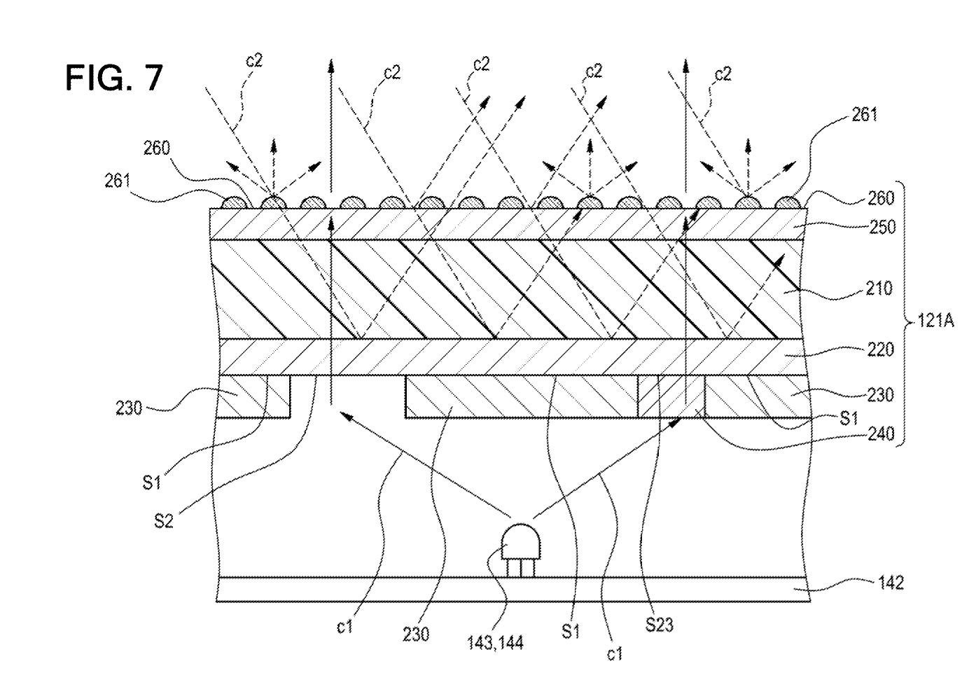

### DESCRIPTION OF EMBODIMENTS

Preferred embodiments of an indicating instrument dial plate according to the present invention will be now described in detail with reference to the accompanying drawings.

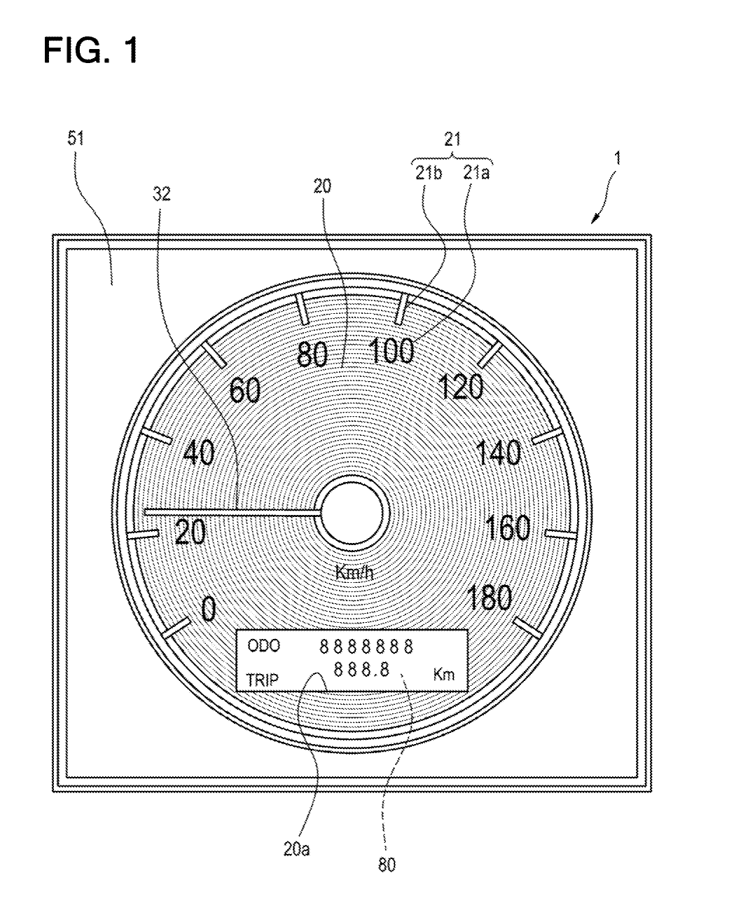

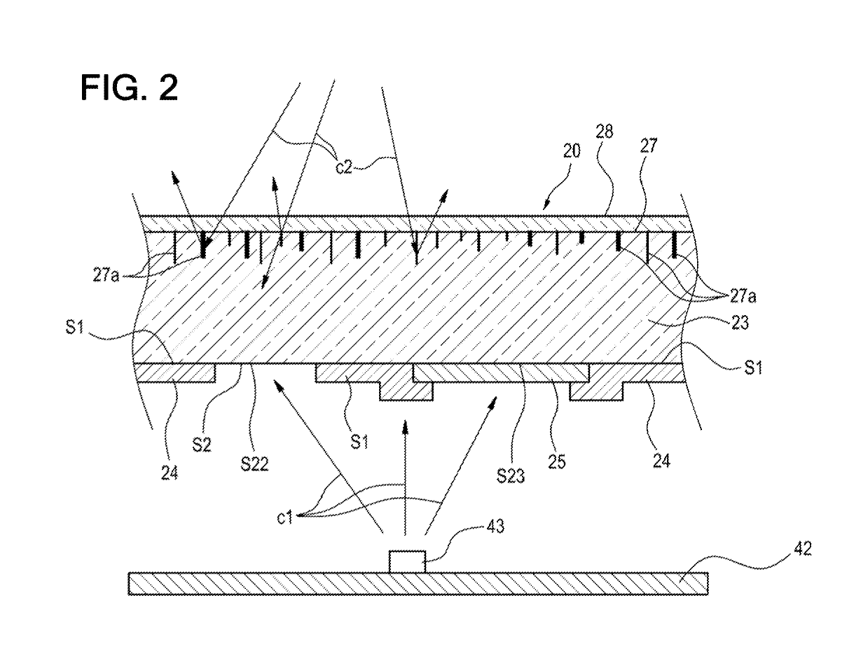

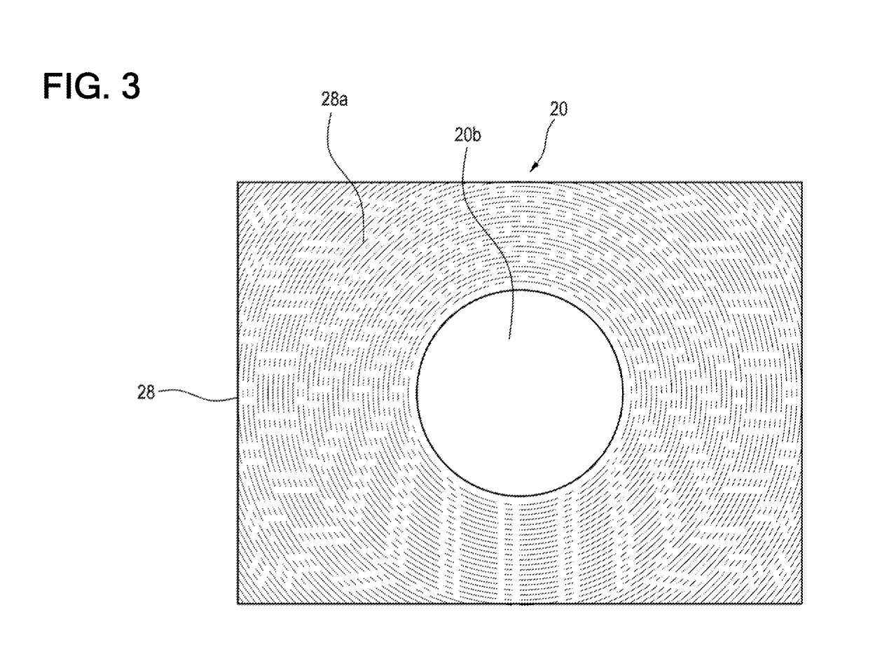

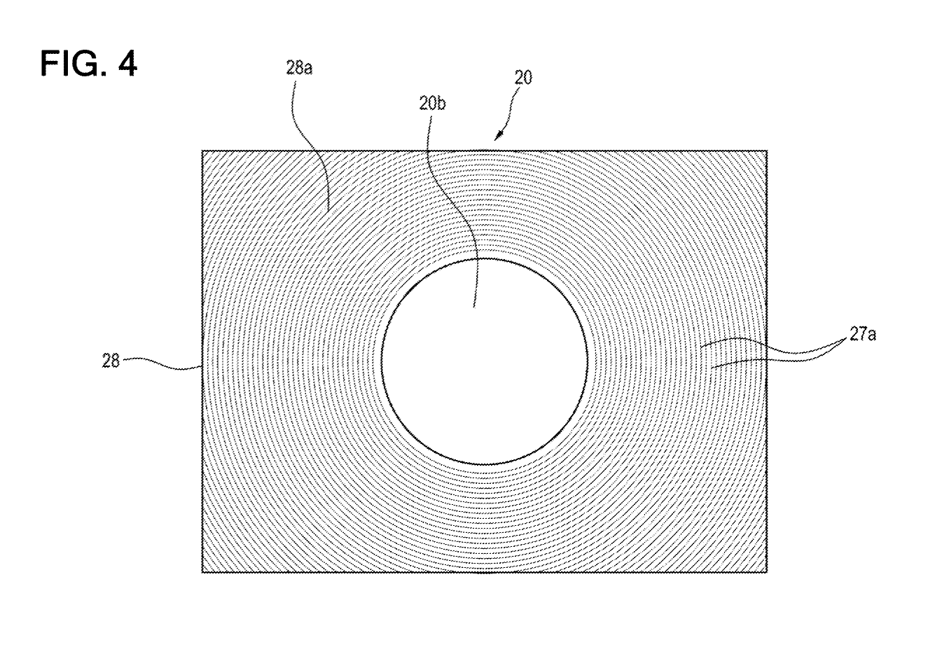

FIGS. 1 to 4 shows one embodiment of an indicating instrument according to the present invention, in which FIG. 1 is a front view showing a speedometer as one embodiment of an indicating instrument in which an indicating instrument dial plate according to the invention is used, FIG. 2 is a longitudinal sectional view showing a structure of the indicating instrument dial plate used in the speedometer of FIG. 1, FIG. 3 is an explanatory view showing an appearance of the indicating instrument dial plate in a non-operating state of the speedometer shown in FIG. 1 as viewed from the front thereof, and FIG. 4 is an explanatory view showing an appearance of the indicating instrument dial plate in an operating state of the speedometer shown in FIG. 1 as viewed from the front thereof.

The speedometer shown in FIG. 1 is a speedometer 1 for vehicles, which has an indicating instrument dial plate 20 equipped inside a facing 51 attached on a front end of a case (not shown).

As shown in FIG. 1, the indicating instrument dial plate 20 has a surface, on which indexes 21, such as characters 21a and scales 21b, required to notify a measured value (i.e., a driving speed of vehicles) are arranged. The characters 21a or scales 21b are arranged on the surface of the indicating instrument dial plate 20 in a circumference shape about the rotation center of an indicator 32.

Similarly, in the case of the present embodiment, the indicating instrument dial plate 20, as shown in FIG. 1, is also provided with a transparent window portion 20a in which an LCD (Liquid Crystal Display) unit 80 for displaying a measured information is disposed

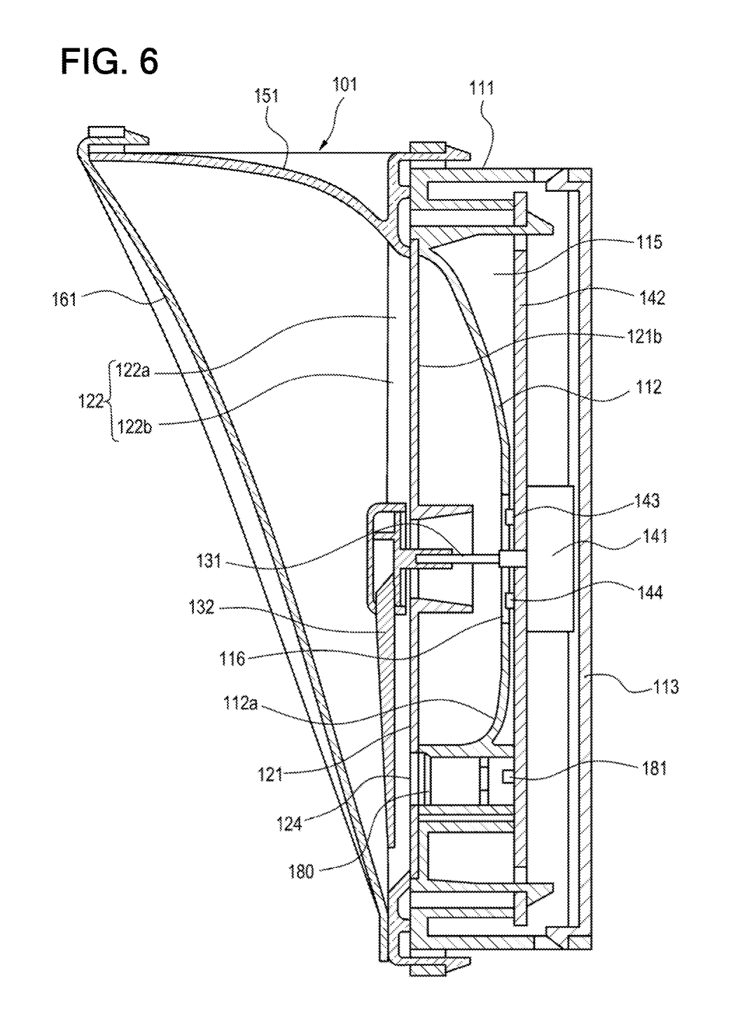

Meanwhile, although the description of each component of the speedometer 1 will be omitted, structures of the case (not shown), the facing 51 attached on the front end of the case, the indicator 32 and the like may be identical to those of the speedometer 101 shown in FIG. 6.

As shown in FIG. 2, the indicating instrument dial plate 20 according to the present embodiment includes a substrate 23, a light-shielding layer 24, a colored layer 25, a hairline-treated surface 27, and a half-mirror layer 28.

The substrate 23 is formed in a plate shape by a transparent or semi-transparent material. The indexes 21, such as characters 21a and scales 21b, shown in FIG. 1 are arranged on a surface of the substrate 23. The substrate 23 has a rear surface on which a dial plate illumination light cl from a first light source 43 mounted on a control board 42 is irradiated.

The control board 42 is a component corresponding to the control board 142 shown in FIG. 6. The first light source 43 is a component corresponding to the first light sources 143 and 144 shown in FIG. 6.

The light-shielding layer 24 is provided in a stacked state in a first region S1, which is defined by a portion of the rear surface of the substrate 23 facing the first light source 43, so that the first region S 1 is finished as a light-shielding area through which the dial plate illumination light c1 of the first light source 43 is not transmitted.

The colored layer 25 is provided in a stacked state in a third region S23 defined in a portion of a second region S2, which is an area of the rear surface of the substrate 23 except the first region S1. The colored layer 25 is a layer formed by applying a resin material (i.e., a printing process), through which the dial plate illumination light cl can be transmitted. The colored layer 25 allows the dial plate illumination light c1, which is transmitted through the third region S23, to be colored by a predetermined color and then transmitted through the substrate 23. Therefore, an area of the substrate 23, which is defined as the third region S23, develops the color of the colored layer 25, thereby achieving an improvement of visibility due to coloring and the like.

On an area (i.e., a region S22 in FIG. 2) of the second region S2, which is not defined as the third region S23, the colored layer is not formed, and as a result, the dial plate illumination light c1 from the first light source 43 is intactly transmitted through the substrate 23. The region S22, which is a portion of the second region S2, is used, for example, as the window portion 20a shown in FIG. 1.

According to the present embodiment, the hairline-treated surface 27 is an uneven surface of a hairline pattern provided on the surface of the substrate 23 by forming a plurality of fine line-shaped grooves 27a on the surface of the substrate 23 by a machine tool, such as a lathe. In other words, according to the present embodiment, the surface of the substrate 23 itself is finished as the hairline-treated surface 27.

By providing the hairline-treated surface 27, an external light c2 incident on the surface of the substrate 23 is diffused by the hairline-patterned unevenness. As a result, on the surface of the substrate 23, a matte effect is created, and also an effect of emphasizing a metallic texture is created. Namely, the hairline-treated surface 27 exhibits the metallic texture on the surface of the substrate 23 by diffusing the external light c2 incident on the surface of the substrate 23 by means of the hairline-patterned unevenness.

The half-mirror layer 28 is provided in a stated state on the surface of the substrate 23 to cover a surface of the hairline-treated surface 27. In the present embodiment, the half-mirror layer 28 is formed in a shape of a thin film covered on the top of the hairline-treated surface 27 by sputtering. In addition, the half-mirror layer 28 is formed to allow a portion of the external light c2 to be transmitted into the substrate 23 and also to allow a portion of the external light to be reflected.

In a non-operating state of the speedometer 1, in which the dial plate illumination light c1 from the first light source 43 is not irradiated thereon, the indicating instrument dial plate 20 described above, as shown in FIG. 3, is configured such that a surface portion 28a of the half-mirror layer 28 around a shaft inserting through-hole 20b through which a shaft of the indicator 32 is inserted, exhibits a design of a generally uniform monotone metallic texture due to the diffusion of the external light c2 by the hairline-treated surface 27.

Contrarily, in an operating state of the speedometer 1, in which the dial plate illumination light c1 from the first light source 43 is irradiated thereon, the dial plate illumination light c1 is diffused by the grooves 27 of the hairline-treated surface 27, so that the grooves 27a are faintly projected, and also in an area corresponding to the third region S23, a design created by the color development due to the colored layer 25 is exhibited.

According to the indicating instrument dial plate 20 of the embodiment as described above, the hairline-patterned unevenness structure creating the metallic texture design on the surface of the dial plate is formed by providing fine line-shaped grooves 27a on the surface of the substrate 23. Namely, the surface of the substrate 23 itself is formed as the hairline-treated surface 27. In addition, the half-mirror layer 28 is formed on the top of the hairline-treated surface 27 by sputtering, and reduces the external light to be incident on the hairline-treated surface 27. As a result, even if a smoke layer for especially reducing the external light is not provide, the diffusion and reflection of the external light on the surface of the substrate 23 can be inhibited, thereby preventing an occurrence of glaring.

In other words, even if the smoke layer is not provided, the metallic texture design, which does not cause glaring and is stable, can be embodied on the surface of the dial plate. Therefore, by omitting the smoke layer which has been provided, the manufacturing steps of the indicating instrument dial plate can be simplified, thereby reducing the manufacturing cost of the indicating instrument dial plate. As a result, the metallic texture design, which does not cause glaring and is stable, can be embodied on the surface of the dial plate at a low cost.

In addition, the hairline-patterned unevenness structure creating the metallic texture design is protected by the half-mirror layer 28 covered thereon. Thus, it is possible to prevent the hairline-patterned unevenness structure from being damaged due to contact with the surrounding objects during storage or the like. In other words, an occurrence of a matter, in which the quality of the metallic texture is deteriorated in a portion of the surface of the dial plate due to damage of the hairline-patterned unevenness structure, can be prevented.

Therefore, the quality of the metallic texture can be easily maintained, and thus, the quality control of the indicating instrument dial plate can be facilitated.

Further, according to the indicating instrument dial plate 20 of the embodiment as described above, in a non-operating state of the speedometer 1, in which the dial plate illumination light cl is not irradiated on the rear surface of the indicating instrument dial plate 20, the metallic texture design, which does not cause glaring and is stable, can be imparted to the speedometer 1. Also, in an operating state of the speedometer 1, in which the dial plate illumination light cl is irradiated on the rear surface of the indicating instrument dial plate 20, the third region S23 defined on the indicating instrument dial plate 20 can develop the color of the colored layer 25. Therefore, a variety of indicating instrument dial plates 20, which are different in the color developing region or the developed color in the speedometer 1, can be relatively easily provided by design modifications in the shape of the third region S23 or the color of the colored layer 25, and thus specification changes of indicating instruments or the like can be easily coped with.

The present invention is not limited to the foregoing embodiments, but appropriate changes, modifications or the like thereof can be made. In addition, material, shape, dimension, number, installation position and the like of each of the components of the foregoing embodiments are not limited but arbitrary as long as the present invention can be achieved.

For example, the indicating instrument employing the indicating instrument dial plate according to the present embodiment is not limited to the speedometer for vehicles as described in the foregoing embodiment. The indicating instrument dial plate can be also applied to indicating instruments (e.g., a tachometer) mounted in vehicles, other than the speedometer. In addition, the indicating instrument dial plate can be applied to a variety of indicating instruments used in facilities other than vehicles. Now, features of embodiments of the indicating instrument dial plate according to the present invention as described above will be briefly summarized and listed in the following [1] and [2].

[1] An indicating instrument dial plate (20), including:

a substrate (23) that is formed in a plate shape, made of a transparent or semi-transparent material, has a front face including a hairline-treated surface and has a rear face which is irradiated with a dial plate illumination light (cl) from a light source (43) inside an indicating instrument; and

a half-mirror layer (28) that is formed in a shape of a thin film covering the hairline-treated surface (27) by sputtering and adapted to allow a portion of external light (c2) incident to the front face of the substrate (23) from the outside of the indicating instrument to be transmitted into the substrate (23) and to allow a portion of the external light (c2) to be reflected,

wherein the hairline-treated surface is made by forming fine line-shaped grooves (27a) on the front face of the substrate (23), and

wherein the hairline-treated surface (27) includes hairline-patterned unevenness which diffuses the external light (c2) to impart a metallic texture to the front face of the substrate (23).

[2] The indicating instrument dial plate (20) according to [1], further including:

a light-shielding layer (24) that is provided in a first region (S1) which is a portion of the rear face of the substrate (23) facing the light source (43) and shields the dial plate illumination light of the light source (43); and

a color layer (25) that is provided in a third region (S23) which is a portion of a second region (S2) which is the rear face of the substrate (23) except the first region (S1) to allow the dial plate illumination light (c1) to be transmitted through the color layer (25) and colors the dial plate illumination light transmitted through the third region (S23) predetermined color.

What is claimed is:

1. An indicating instrument dial plate comprising:
a substrate that is formed in a plate shape, made of a transparent or semi-transparent material, has a front face including a hairline-treated surface and has a rear face which is irradiated with a dial plate illumination light from a light source inside an indicating instrument; and
a half-mirror layer that is formed in a shape of a thin film covering the hairline-treated surface by sputtering and adapted to allow a portion of external light incident to the front face of the substrate from the outside of the indicating instrument to be transmitted into the substrate and to allow a portion of the external light to be reflected,
wherein the hairline-treated surface is made by forming fine line-shaped grooves on the front face of the substrate, and
wherein the hairline-treated surface includes hairline-patterned unevenness which diffuses the external light to impart a metallic texture to the front face of the substrate.

2. The indicating instrument dial plate according to claim 1 further comprising:
a light-shielding layer that is provided in a first region which is a portion of the rear face of the substrate facing the light source and shields the dial plate illumination light of the light source; and
a color layer that is provided in a third region which is a portion of a second region which is the rear face of the substrate except the first region to allow the dial plate illumination light to be transmitted through the color layer and colors the dial plate illumination light transmitted through the third region predetermined color.

3. The indicating instrument dial plate according to claim 1, wherein a smoke layer which reduces reflection of the external light by the front face of the substrate is not included in the indication instrument dial plate.
